(19) United States
(12) Patent Application Publication
(10) Pub. No.: US 2026/0275053 A1
(43) Pub. Date: Sep. 17, 2026

(54) ADHESION-PREVENTING FILM

(71) Applicants: KUREHA CORPORATION, Tokyo (JP); NATIONAL UNIVERSITY CORPORATION KOBE UNIVERSITY, Kobe-shi (JP)

(72) Inventors: Hironao SHIMADA, Tokyo (JP); Takashi MASAKI, Tokyo (JP); Shin SUZUKI, Tokyo (JP); Kazuhisa TAKATSUJI, Houston, TX (US); Takumi FUKUMOTO, Hyogo (JP)

(73) Assignees: KUREHA CORPORATION, Tokyo (JP); NATIONAL UNIVERSITY CORPORATION KOBE UNIVERSITY, Kobe-shi (JP)

(21) Appl. No.: 19/674,557

(22) Filed: May 12, 2026

Related U.S. Application Data
(63) Continuation-in-part of application No. 17/907,336, filed on Mar. 31, 2021.

(30) Foreign Application Priority Data
Mar. 31, 2020 (JP) 2020-064458

(51) Int. Cl. C08J 3/00; B29C 39/00; B29C 39/02; B29K 1/00; B29K 67/00; B29L 7/00; C08J 3/05

(52) U.S. Cl. CPC C08J 3/005; B29C 39/003; B29C 39/02; C08J 3/05; B29K 2001/08; B29K 2005/00; B29K 2067/043; B29K 2067/046; B29K 2995/006; B29L 2007/008; C08J 2305/08; C08J 2401/10; C08J 2467/04

(57) ABSTRACT

An embodiment of the present invention is to provide an adhesion barrier film including: a derivative of a polyanionic polysaccharide, where
the adhesion barrier film contains 3 mass % or greater of biodegradable polyester particles having an average particle size of 1 μm or greater and 60 μm or less,
a number average molecular weight Mn of the biodegradable polyester particles is 1,000 Da or greater and less than 30,000 Da, and
a content A mass % of the biodegradable polyester with respect to the number average molecular weight Mn of the biodegradable polyester satisfies an expression below:

$$A ≧ 1.0 \times 1 {0}^{- 8} {Mn}^{2} + 6.0 \times 1 {0}^{- 5} Mn + 2.68 .$$

### CROSS-REFERENCE TO RELATED APPLICATIONS

This application is a continuation-in-part of U.S. patent application Ser. No. 17/907,336, filed on Sep. 26, 2022, which is a national stage application under 35 U.S.C. § 371 of International Application No. PCT/JP2021/013973, filed on Mar. 31, 2021, which claims priority to Japanese Patent Application No. 2020-064458, filed on Mar. 31, 2020. The entire disclosures of the foregoing applications are incorporated herein by reference.

### TECHNICAL FIELD

The present invention relates to an adhesion barrier film for medical use.

### BACKGROUND ART

Polyanionic polysaccharides (hereinafter may be abbreviated as “PAS”), such as hyaluronic acid (hereinafter may be abbreviated as “HA”), carboxymethyl cellulose (hereinafter may be abbreviated as “CMC”), carboxymethyl amylose (hereinafter may be abbreviated as “CMA”), and alginic acid, exhibit excellent solubility in water, adequate viscosity, tackiness, moisture-retaining property, and biocompatibility. Thus, PAS are widely used as additives for food, medical materials, cosmetics, and articles for daily use. Among PAS, HA is a commonly and widely used compound.

HA is a glycosaminoglycan (natural mucopolysaccharide) present in many locations in the human body. HA is a common extracellular matrix component and is also present in tissues such as vitreous humor, blood vessel walls, and umbilical cord. Since HA is highly safe for the human body, it is used in various fields, such as food, cosmetics, and medical and pharmaceutical products. In particular, HA and compositions containing HA are used as raw materials for joint function improving agents and adhesion barrier films for body tissues after surgery in the medical field (U.S. Pat. No. 5,017,229). When HA or a composition containing HA is used as the adhesion barrier film, the film placed on the wounded tissue surface is required to retain its shape for a period of time necessary to prevent adhesion between the tissues, and thereafter, the film is required to dissolve by moisture and be safely absorbed into the body. However, because HA has a high dissolution rate in water, a molded article such as a film made of HA or a composition including HA has a problem in that it is difficult to retain the shape of the molded article for a long period of time in a living body or on a body surface where moisture such as body fluid is also present.

As a method for reducing the water solubility of HA, a method using a crosslinking reaction that utilizes a carboxyl group present in an HA molecule is known. U.S. Pat. No. 6,294,202 proposes a biocompatible composition containing PAS and a hydrophobic bioabsorbable polymer. HA, CMC, CMA, and the like are exemplified as PAS. U.S. Pat. No. 6,294,202 discloses a PAS derivative rendered water-insoluble by reacting the PAS with an activating agent such as a carbodiimide or 1-ethyl-3-(3-dimethylaminopropyl) carbodiimide (EDC), and also an adhesion barrier film using a composition containing the PAS derivative. U.S. Pat. No. 6,294,202 further describes an adhesion barrier film using a composition combining PAS with a hydrophobic bioabsorbable polymer such as polyglycolide, (D-, L-, DL-) polylactide, polydioxanone, or a copolymer thereof, aiming to improve mechanical strength and extend residence time in the body.

### SUMMARY OF INVENTION

### Technical Problem

U.S. Pat. No. 6,294,202 describes a PAS derivative in which a functional group of PAS is chemically modified by adding a carbodiimide or the like as an activating agent to reduce the solubility of PAS in water. Furthermore, U.S. Pat. No. 6,294,202 proposes an adhesion barrier film composed of a composition containing a PAS derivative.

An adhesion barrier film is required to remain between wounded tissues that may form adhesion and to act as a temporary barrier to prevent adhesion at the wound site, and after the wound site heals and there is no longer a risk of adhesion, the film is required to dissolve and be safely absorbed into the body. The inventors of the present application have also produced a prototype adhesion barrier film from an HA/CMC solution in which EDC was added as an activating agent to the PAS composition and verified the shape retention in a buffer solution and the adhesion prevention effect using test animals, but the intended effect was not observed.

As a method other than suppressing solubility in water by chemical modification of a functional group of PAS, U.S. Pat. No. 6,294,202 proposes a method in which one side or both sides of a PAS composition are coated with a hydrophobic bioabsorbable polymer. However, when only one side of the composition is coated, moisture absorption occurs only on the one side, and the volume expansion rate accompanying swelling differs greatly between surfaces of the film, so there is a risk that the film curls and peels off from the wound site. A film that coats both sides of a PAS composition film with a hydrophobic bioabsorbable polymer has a problem of low adherence to the wound site due to low swelling property. Furthermore, U.S. Pat. No. 6,294,202 describes a method in which a hydrophobic bioabsorbable polymer (biodegradable polyester) is mixed with a PAS solution to disperse hydrophobic bioabsorbable polymer fibers in a solution of a PAS composition. This method improves the mechanical strength of a molded article (film) containing the PAS composition with the fibers, but does not suppress the solubility in water of the PAS composition, which is the matrix. In the studies by the present inventors, results were also obtained showing that commercially available polyglycolic acid sutures, which are hydrophobic bioabsorbable polymers, generate only a small amount of acid in ultrapure water. Therefore, dispersing hydrophobic bioabsorbable polymer fibers in a PAS composition is not expected to provide an effect of retaining a film shape through acid generation in a hydrated state.

JP 2004-51531 A reports that, when the dissolution half-life of water-insolubilization-treated CMC is short, adequate adhesion prevention performance cannot be exhibited even when the material is applied on and around a wound surface in a body.

Furthermore, an adhesion barrier film is used by grasping the film with tweezers or the like during open abdominal surgery and attaching the film to an organ. Alternatively, when an adhesion barrier film is used by inserting the film during laparoscopic surgery, the film is rolled into a tubular shape, grasped with forceps, introduced into the body, then deployed (returned to its original shape), and attached to an organ. Therefore, the adhesion barrier film is required to not easily droop when grasped with tweezers or the like until the attachment or when grasped with forceps, and furthermore, is required to be easily rollable and to be easily deployable in the body. Since hydrophobic bioabsorbable polymer fibers made of polyglycolide or the like have high rigidity, adhesion barrier films containing the fibers have low flexibility.

The present invention has been made in view of the problems of these known techniques, and an object of the present invention is to provide an adhesion barrier film that retains its shape for a period of time necessary for wound healing on the surface of a wound site where adhesion prevention is desired, exhibits an effect of adhesion prevention, and has excellent flexibility.

### Solution to Problem

As a result of studying the problems described above, the present inventors have found that an adhesion barrier film containing a PAS derivative in which a biodegradable polyester (hereinafter, may be referred to as “PEs”) is dispersed excels in retaining its shape for a period of time necessary for healing a wound site when the film is placed in a body, and furthermore has solubility with minimal risk of foreign-body reaction or the like due to remaining for a long term. The gist of embodiments of the present invention are as follows. An embodiment of the present invention for solving the above problems relates to the adhesion barrier film and the method of producing the adhesion barrier film described in the following [1] to [6].
[1] An adhesion barrier film, including:
   a derivative of a polyanionic polysaccharide, where
   the adhesion barrier film contains 3 mass % or greater of biodegradable polyester particles having an average particle size of 1 μm or greater and 60 μm or less,
   a number average molecular weight Mn of the biodegradable polyester particles is 1,000 Da or greater and less than 30,000 Da, and
   a content A mass % of the biodegradable polyester with respect to the number average molecular weight Mn of the biodegradable polyester satisfies an expression below:

$$A ≧ 1.0 \times 1 {0}^{- 8} {Mn}^{2} + 6.0 \times 1 {0}^{- 5} Mn + 2.68 .$$

[2] The adhesion barrier film according to [1], where
   loop stiffness of the adhesion barrier film is 0.05 N/10 mm or greater and 0.30 N/10 mm or less.
[3] The adhesion barrier film according to [1] or [2], where
   the average particle size of the biodegradable polyester particles is 10 μm or greater and 30 μm or less.
[4] The adhesion barrier film according to any one of [1] to [3], where the derivative of the polyanionic polysaccharide contains at least hyaluronic acid or a derivative thereof and carboxymethyl cellulose or a derivative thereof as structural units.
[5] The adhesion barrier film according to any one of [1] to [4], where the biodegradable polyester particles are particles of a homopolymer of glycolic acid or lactic acid, or particles of a copolymer of glycolic acid and lactic acid.
[6] A method for producing the adhesion barrier film according to any one of [1] to [5], the method including:
   preparing an aqueous solution containing a derivative of a polyanionic polysaccharide;
   preparing biodegradable polyester particles having an average particle size of 1 μm or greater and 60 μm or less;
   mixing and dispersing the biodegradable polyester particles in the aqueous solution to form a slurry; and
   casting the slurry to obtain a film.

### BRIEF DESCRIPTION OF THE DRAWINGS

FIG. 1 is a photograph of a typical external appearance with a score of 2 in external appearance evaluation in an example of the present invention.

FIG. 2 is a photograph of a typical external appearance with a score of 1 in external appearance evaluation in an example of the present invention.

FIG. 3 is a graph showing the relationship between the number average molecular weight Mn of the biodegradable polyester particles and the content of the biodegradable polyester particles in an adhesion barrier film required for retaining a planar shape even after immersion in water for 120 hours, and an approximation curve approximated by a quadratic function using the least squares method.

### DESCRIPTION OF EMBODIMENTS

The present invention provides an adhesion barrier film that, when applied to a wound site of a body, adheres closely to the surface of the wound site where adhesion prevention is desired, and exhibits an effect of wound healing or adhesion prevention—the adhesion barrier film further has flexibility that enables easy insertion of the film into the wound site—, and a method for producing the adhesion barrier film.

Although the reason why the shape retention of an adhesion barrier film containing polyanionic polysaccharide (PAS) is improved by the presence of PEs particles is not clear, the inventors consider it to be as follows. PEs such as polyglycolic acid (hereinafter, may be referred to as “PGA”) and polylactic acid (hereinafter, may be referred to as “PLA”) are hydrolyzed by water contained inside a film that contains a PAS derivative, thereby generating acid. Since the PAS derivative has dissociated carboxyl groups (—COO—), the PAS derivative has a strong affinity with water molecules and high solubility. The pKa of a carboxyl group is approximately 3.5, and carboxyl groups are protonated (—COOH) in the presence of an acid. As a result, polarity of a PAS molecule is weakened, electrostatic repulsion between molecules is reduced, and molecular chains are easily brought close to each other, so that hydrogen bonding or hydrophobic interaction between the carboxyl groups or with other functional groups is strengthened. On the other hand, protonation of carboxyl groups weakens the affinity with water molecules. By these actions, it is presumed that the solubility of PAS in water decreases and the shape retention of the adhesion barrier film is enhanced.

Embodiments of the present invention will be described in detail below, but the present invention is not limited to the following embodiments.

The adhesion barrier film of the present invention contains a PAS derivative and PEs particles dispersed in the PAS derivative. When the adhesion barrier film of the present invention is placed in the body, the adhesion barrier film swells by absorbing moisture in the body, and the adhesion barrier film adheres closely to the wound site.

The structure of the adhesion barrier film of the present invention can be appropriately selected in a range that allows application of the adhesion barrier film to a body, and may be, for example, a single-layer structure containing only a PAS derivative and PEs particles, or may be a multilayer structure containing an additional layer. A single-layer adhesion barrier film can be obtained as a continuous film or porous single-layer film obtained by, for example, pouring a liquid mixture of a PAS derivative and PEs particles into an appropriate container, followed by drying. A multi-layer adhesion barrier film can be obtained by closely adhering an additional layer to the obtained single-layer film as necessary, followed by treatment with heat or the like.

### (Polyanionic Polysaccharide)

The adhesion barrier film of the present invention contains a derivative of PAS. The PAS derivative is PAS whose crosslinked structure and/or chemical properties such as ionic properties and hydrophilicity have been adjusted (chemically modified). The PAS derivative may be a derivative composed of the same type or different types of PAS. By adjusting the chemical properties, various physical properties, such as water solubility and mechanical properties, of the PAS derivative can be controlled.

PAS to be used for the PAS derivative may be a salt. Examples of salts of PAS include alkali metal salts such as sodium salts and potassium salts, and alkaline earth metal salts such as calcium salts and magnesium salts.

The PAS may be a natural compound, or may be a compound synthesized by artificially introducing an anionic group into a naturally derived or artificially synthesized compound. Examples of the natural PAS include pullulan, alginic acid, hyaluronic acid, chondroitin sulfate, and pectin. Examples of the PAS synthesized by artificially introducing an anionic group include CMA, CMC, carboxymethyl dextran, carboxymethyl starch, sulfated cellulose, and sulfated dextran. From the perspective of safety in a body and ease of handling, HA and CMC are preferred as the PAS. These PAS can be used alone or in combination of two or more types.

The PAS derivative is obtained by treating PAS with an activating agent. By treating PAS with an activating agent, the solubility of the PAS in water can be reduced, thereby enabling the production of a gel-like PAS derivative that does not dissolve in water and yet absorbs water and swells. Examples of the activating agent include carbodiimides, triazines, and imidazoles. Specific examples of the carbodiimides include 1-ethyl-3-(3-dimethylaminopropyl) carbodiimide (EDC), N,N′-dicyclohexylcarbodiimide, N,N′-diisopropylcarbodiimide, and N-cyclohexyl-N′-(2-morpholinoethyl) carbodiimide metho-p-toluenesulfonic acid, and the EDC that can be used in an aqueous solvent is preferred.

For example, EDC reacts with an anionic substituent, such as a carboxy group, in the molecule of PAS. By this reaction, a mixture of N-acylurea that is relatively stable and O-acylisourea intermediate that is unstable is formed. By this reaction, a cationic substituent is introduced into the molecule of PAS. As a result, intermolecular interactions of PAS are strengthened and hydration becomes difficult, enabling the production of a PAS derivative having reduced solubility of the PAS in water.

### (Biodegradable Polyester)

However, even a PAS derivative that is made less likely to be hydrated by chemical modification does not have sufficiently low solubility in water to retain its shape until the wound site in the body is healed. In contrast, an adhesion barrier film having a structure in which PEs particles are dispersed in a PAS derivative retains its shape for a period of time during which the adhesion barrier film can prevent adhesion at the wound site in the body, and is then safely absorbed into the body.

The PEs is hydrolyzed by moisture absorbed into the adhesion barrier film to generate an acid, thereby suppressing the solubility of the PAS derivative in water and allowing the adhesion barrier film to retain its shape over a long period of time. As the PEs, specifically, polyglycolic acid (hereinafter may be referred to as “PGA”), polylactic acid (hereinafter may be referred to as “PLA”), polycaprolactone, polydioxanone, and copolymers of these, which release an acid upon hydrolysis, are preferred. Among these, a homopolymer of polyglycolic acid (PGA) having a fast hydrolysis rate or a copolymer containing a structural unit derived from glycolic acid as a main component is preferred. Here, containing a structural unit derived from glycolic acid as a main component means that the ratio of the mass of the structural unit derived from glycolic acid to the total mass of PEs is 50 mass % or greater. The mass ratio of the structural unit derived from glycolic acid is more preferably 70 mass % or greater, further preferably 80 mass % or greater, particularly preferably 90 mass % or greater, and a homopolymer of polyglycolic acid is most preferred.

The number average molecular weight Mn of the PEs greatly affects the reaction rate of hydrolysis with water, and the smaller the number average molecular weight Mn, the faster the reaction rate tends to be and the faster the acid generation rate per mass of PEs tends to be. In the present embodiment, the number average molecular weight Mn of the PEs is 1,000 daltons (Da) or greater and less than 30,000 daltons (Da). From the perspective of suppressing the hydrolysis rate of PEs, making the acid generation period sufficiently long, and retaining the shape of the adhesion barrier film for the necessary period of time in the body, the number average molecular weight Mn of PEs is preferably 1,000 Da or greater. The number average molecular weight Mn of PEs is more preferably 2,000 Da or greater, and further preferably 3,000 Da or greater. Furthermore, by setting the number average molecular weight Mn of PEs to less than 30,000 Da, an acid can be generated at an appropriate rate to retain the shape of the adhesion barrier film. The number average molecular weight Mn of the PEs is preferably 25,000 Da or less, more preferably 20,000 Da or less, and further preferably 15,000 Da or less. The molecular weights described above are the preferred molecular weights at the time of film production. The number-average molecular weight of the PEs may decrease during the production of the film. Therefore, the PEs in the film production has a number-average molecular weight of preferably 1,000 or more and 9,000 or less, more preferably 3,000 or more and 9,000 or less, and even more preferably 4,000 or more and 8,000 or less. As described above, the number average molecular weight Mn of PEs can serve as one means for adjusting an acid release period, for retaining the shape of the adhesion barrier film, to a desired period until the wound site is healed.

The acid generation ability by hydrolysis of PEs can be measured by titration using 1,8-diazabicyclo[5.4.0]-7-undecene (DBU), as described in Examples below.

The number average molecular weight Mn of PEs particles contained in an adhesion barrier film can be measured and determined in accordance with ISO 16014-1:2012. Specifically, after the film is cut into 30 mm squares, the film is immersed in a 50-mL vial to which 4 mL of concentrated hydrochloric acid (35-37% (mass percent concentration) available from Kanto Chemical Co., Inc.) has been added, and sonicated for 30 minutes. The solution after the sonication is diluted by adding ultrapure water and filtered through a 0.45-μm membrane filter, and then the residue on the filter is vacuum-dried at 25° C. The dried residue is transferred to a 10-mL volumetric flask, 0.5 mL of super dehydrated dimethyl sulfoxide is added, and the mixture is heated in an oil bath at 160° C. for 5 minutes. After the volumetric flask is allowed to cool to room temperature, a solution of 5 mM CF₃COONa dissolved in hexafluoropropanol (HFIP) is added to the flask to a total volume of 10 mL, and insoluble matter is removed from the resulting mixture by filtration through a filter to prepare a sample solution. The sample solution is measured by gel permeation chromatography (GPC) (apparatus: Shodex GPC-104 available from Resonac Holdings Corporation; detector: RI; column: HFWIP-606M×2; flow rate: 0.40 mL/min; temperature: 40° C.) using poly(methyl methacrylate) (PMMA) as a standard material. From a chromatogram obtained by the measurement, the number-average molecular weight Mn is calculated by molecular weight calculation using a calibration curve.

Furthermore, since PEs with a small number average molecular weight Mn generates a large amount of acid in a short period of time, solubility in water can be suppressed even in a range where the content of the PEs in the adhesion barrier film is low. The content A mass % of PEs relative to the number average molecular weight Mn of PEs satisfies Expression 1.

$$A \geq 2 \times 1 {0}^{- 9} {Mn}^{2} + 2 \times 1 {0}^{- 5} Mn + 8 \qquad [ Expression 1 ]$$

The PEs having a number average molecular weight Mn in the above range is preferably contained at 3 mass % or greater based on the total mass of the adhesion barrier film. This allows the adhesion barrier film placed at the wound site in the body to generate an acid necessary to retain the shape of the film for a sufficiently long period. The content of PEs having a number average molecular weight Mn in the above range is preferably 3 mass % or greater and 40 mass % or less based on the total mass of the adhesion barrier film, more preferably 5 mass % or greater and 30 mass % or less, and further preferably 10 mass % or greater and 30 mass % or less. When the content of PEs is 30 mass % or less, the thickness of the adhesion barrier film does not increase significantly, and handleability is favorable. Furthermore, since aggregation of PEs particles is less likely to occur during film production and PEs particles can be uniformly dispersed in the film, thereby allowing the film to uniformly retain its shape over the entirety thereof.

The adhesion barrier film may contain PEs having a number average molecular weight Mn of 30,000 Da or greater. However, PEs having a large number average molecular weight Mn does not have a sufficient acid generation rate to retain the shape of the film, and the effect of such PEs is not expected to be significant. To prevent a decrease in high adherence due to the PAS derivative absorbing moisture and swelling, the content of PEs having a number average molecular weight Mn of 30,000 Da or greater is preferably less than 5 mass % based on the total mass of the adhesion barrier film, more preferably less than 1 mass %, further preferably less than 0.1 mass %, and particularly preferably 0 mass % (i.e., not included).

The content of PEs described above is the amount based on the total mass of the adhesion barrier film in a dry state. The adhesion barrier film is usually in a dry state, but since the film may absorb moisture from the atmosphere, the mass of the adhesion barrier film is measured in an environment at room temperature (25° C.) and relative humidity of 50% or less after removing moisture in the film by vacuum drying for about 1 hour at room temperature (25° C.). Thereafter, the PEs content can be measured by taking out only the PEs particles from the adhesion barrier film and measuring only the mass of the PEs particles. Furthermore, it is also possible to measure the molecular weight distribution of PEs by the method described in the Examples below and calculate only the mass of PEs having a number average molecular weight Mn of 1,000 Da or greater and less than 30,000 Da.

The shape of PEs is not particularly limited as long as the PEs can be uniformly dispersed in a film containing the PAS derivative. For uniform dispersion, powder form, spherical form, and similar shapes are preferred. Fibrous PEs is not preferred because fibrous PEs is difficult to uniformly disperse within the PAS derivative.

The average particle size of PEs is 1 μm or greater and 60 μm or less. By setting the average particle size of PEs to 1 μm or greater, rapid hydrolysis reactions due to increased reaction area with moisture can be suppressed, making PEs less likely to be consumed in a short time, thereby facilitating retention of the shape of the adhesion barrier film over a long period of time. In addition, uniform mixing of the PAS derivative solution and PEs particles can be achieved. The average particle size of PEs is preferably 5 μm or greater, and more preferably 10 μm or greater. In addition, by setting the average particle size to 60 μm or less, a sufficient reaction area for hydrolysis by water can be ensured, and a sufficient amount of acid can be generated to facilitate retention of the shape of the adhesion barrier film. In addition, by setting the average particle size to 60 μm or less, the number of particles dispersed in the PAS derivative can be increased, and PEs particles can be uniformly dispersed in the adhesion barrier film, thereby allowing the film to uniformly retain its shape over the entirety thereof. In addition, by not making the average particle size excessively large, an increase in loop stiffness due to increased thickness of the adhesion barrier film can be suppressed, and stress concentration and formation of interface defects caused by coarse particles can be suppressed. The average particle size of PEs is preferably 50 μm or less, more preferably 40 μm or less, and even more preferably 30 μm or less.

The average particle size of PEs particles before dispersion can be measured by the method described in Particle Size Analysis—Laser Diffraction/Scattering Method JIS Z 8825:2022 (ISO13320: 2020). The average particle size refers to the particle size at which the volume-based cumulative distribution reaches 50%.

In addition, the average particle size of PEs particles dispersed in the adhesion barrier film can be measured by the following method. The average particle size of PEs particles can be measured by observing 200 or more PEs particles that are not aggregated using a digital microscope (HVX7000, available from Keyence Corporation) at a magnification of 100 times to capture digital images. The captured digital images are read into image analysis software, and the lengths of the perimeters of the PGA particles are measured with an image analyzer. The arithmetic mean (average value) and the standard deviation of the lengths of the perimeters of the PEs particles are calculated, and measured values with a difference from the average value of three or more times the standard deviation are excluded to determine the average perimeter length. An equivalent diameter of the particles obtained by dividing the average perimeter length of the particles by the ratio (3.1416) of the circumference of a circle is defined as the average particle size of PEs particles.

The image processing is performed by reading the digital image into MIPAR (available from Lightstone Corp.) and setting the conditions of the image analysis software as follows.
“Smart Cluster” is set to “Fill Type: Class”, “Classes: 4 to 10”, “Edge Type: Dark to Bright”, “Edge Clean: 0 to 5”, and “Speed: 2”.
“Basic Threshold” is set to “Value: 80 to 150”.
“Reject Features” is set to “Measurement: Area”, “Target: Objects”, “Edges: Include”, “Units: μm²”, “Threshold Value: 100”, and “Type: Reject Features </=”.

### (Characteristics of Adhesion Barrier Film)

The adhesion barrier film has loop stiffness (rigidity) of 0.01 N/10 mm or greater and 0.60 N/10 mm or less, more preferably 0.05 N/10 mm or greater and 0.50 N/10 mm or less, even more preferably 0.05 N/10 mm or greater and 0.30 N/10 mm or less, particularly preferably 0.10 N/10 mm or greater and 0.30 N/10 mm or less, and most preferably 0.13 N/10 mm or greater and 0.30 N/10 mm or less. Loop stiffness is the resistance to bending and is an indicator of so-called “koshi” (firmness). When the loop stiffness of the adhesion barrier film is 0.05 N/10 mm or greater, even when the adhesion barrier film is grasped with forceps or the like for insertion into the body, the film does not droop and easily retains its shape. Furthermore, after inserting a folded or rolled adhesion barrier film into the body, the film easily returns to its original shape and has excellent deployability. When the loop stiffness is 0.30 N/10 mm or less, the flexibility of the film can be ensured, making it easy to be folded or rolled up even with a small force. To improve the handleability of the adhesion barrier film, the balance between the above flexibility and deployability is important.

Loop stiffness is measured by the following method. For a rectangular adhesion barrier film, the film is divided into 4 divided areas by drawing a perpendicular line from the center of each side toward the opposing side. A sample piece can be prepared by cutting the film into a 10 mm×40 mm rectangle so as to include the central portion of each divided area. Here, the central portion of each divided area refers to the region including the intersection of the diagonals of a rectangle defining the divided area. However, when it is difficult to cut out sample pieces by the above method, the cutting method can be appropriately adjusted according to the dimensions of the film. Both ends of the rectangular film (sample piece) in the longitudinal direction are aligned and adhered to each other with double-sided tape at a width of 5 mm from each end to prepare a measurement sample in a loop shape (teardrop shape) with a loop length of 30 mm. Measurement is performed at a temperature of 25° C. and relative humidity of approximately 60% RH, and the portion adhered with the double-sided tape (5 mm) is clamped and fixed in the chuck of a creep meter (RHEONERII RE2-33005B, available from Yamaden Co., Ltd.). To compress the loop of the measurement sample, the upper indenter (30 mm) attached to the creep meter is moved in the loop direction at a speed of 0.5 mm/sec. A load (N) at the time of compression by 5 mm from a contact point is recorded and defined as a loop stiffness value (N/10 mm). Measurement is performed four times (n=4), and the average of the measured values obtained is defined as the loop stiffness value.

The adhesion barrier film preferably has a thickness of 10 μm or greater and 500 μm or less, more preferably 10 μm or greater and 100 μm or less, even more preferably 20 μm or greater and 75 μm or less, and still more preferably 30 μm or greater and 75 μm or less. As the thickness increases, strength of the adhesion barrier film increases and the film becomes less likely to be decomposed in the body, thereby enabling the film to exhibit an adhesion prevention effect for a long period of time. As the thickness decreases, the adhesion barrier film can be more easily folded or rolled up, and handleability of the film when held with forceps or the like is improved.

The thickness of the adhesion barrier film is measured by the following method. For a rectangular adhesion barrier film, the film is divided into 16 divided areas by drawing perpendicular lines from points that divide each side into four equal segments toward an opposing side. The central portion of each divided area is measured with a micrometer (PMU150-25MX, available from Mitutoyo Corporation), and the average value is defined as the film thickness. Here, the central portion of each divided area refers to the region including the intersection of the diagonals of a rectangle defining the divided area. The thickness of the above adhesion barrier film is the thickness in a dry state. The adhesion barrier film is usually in a dry state, but since the film may absorb moisture from the atmosphere, the thickness of the adhesion barrier film is measured in an environment at room temperature (25° C.) and humidity of 50% or less after removing moisture from the film by vacuum drying at room temperature (25° C.) for about 1 hour.

### (Method for Producing Adhesion Barrier Film)

PAS is dissolved in water or a water-based solution in which PAS is soluble to obtain a PAS solution. An activating agent is added to the obtained PAS solution to prepare a solution of a PAS derivative having low solubility in water. PEs particles are added to the prepared PAS derivative solution, and a slurry in which the particles are mixed and dispersed is prepared. The slurry is formed into a film to obtain a film. An adhesion barrier film can be produced by heat pressing the film at a desired temperature.

(1) Production of Polyanionic Polysaccharide Composition having Low Solubility in Water

By treating PAS with an activating agent, the solubility of PAS in water can be reduced. By dissolving at least one type of PAS, such as pullulan, alginic acid, CMC, or CMA, in water or a water-based solution, adding an activating agent and stirring, a PAS derivative having low solubility in water can be obtained. As an example of the method for treating PAS with an activating agent, when EDC is used as the activating agent for PAS, it is preferable to proceed with the reaction under low pH conditions to convert carboxyl groups of PAS to the acid form and promote the reaction with the highly stable EDC, and the pH is preferably set to 4.0 to 5.5. Since the pH increases during the reaction, for example, the pH is preferably adjusted by using an acid, such as 0.1 mol/L hydrochloric acid. As needed, it is preferable to remove low molecular weight components such as unreacted materials and by-products from the obtained reaction solution by dialysis. The dialysis method is not particularly limited, but for example, the reaction solution is placed in a dialysis tube and dialysis is performed while stirring the dialysate. The dialysate may be appropriately replaced as needed. The dialysis tube is not particularly limited and can be appropriately selected according to the purpose, and a regenerated cellulose dialysis tube or the like can be suitably used.

### (2) Pulverization of Biodegradable Polyester Particles and Particle Size Measurement Method

As the biodegradable polyester (PEs), PGA, PLA, polycaprolactone, polydioxanone, and copolymers of these, which release acid upon hydrolysis, can be used. PEs can be pulverized by applying mechanical impact (impact pulverization) to adjust the average particle size. The pulverization method is not particularly limited, but it is particularly preferred to pulverize PEs while applying high shear force at a temperature below the glass transition temperature of PEs.

As a device for pulverization (impact pulverization) while applying high shear force, any pulverization device may be used as long as impact force and shear force have a large contribution among the pulverization actions of compressive force, frictional force, impact force, and shear force. For example, a ball mill, hammer mill, jet mill, cryomill, pin mill, or the like can be used. In addition to impact by a rotor, a turbo mill or the like that performs pulverization using ultra-high-speed vortex flow or high-frequency pressure vibration can be effectively utilized. From the perspective that pulverization efficiency and control of particle size are easy, a jet mill is preferred. In addition, for the purpose of removing fine powder, an air classifier may be combined, a pulverizer may be combined with a sieving machine to efficiently perform pulverization while controlling particle size, or a plurality of pulverization devices may be combined.

The maximum particle size of PEs is preferably smaller than the thickness of the adhesion barrier film. By making the maximum particle size smaller than the thickness of the adhesion barrier film, satisfactory adherence between a wound site and the film can be achieved. From the perspective described above, adjustment of the maximum particle size of PEs can be performed by appropriately selecting the aperture of the sieve used for sieving. The preferred value of the maximum particle size varies depending on the thickness of the adhesion barrier film. In this regard, the PEs is preferably a product that passes through a sieve with a nominal aperture of 90 μm according to JIS Z8801-1, more preferably a product that passes through a 63 μm sieve, further preferably a product that passes through a 45 μm sieve, and particularly preferably a product that passes through a 38 μm sieve.

### (3) Slurry Preparation, Film Formation, and Heat Treatment Method

PEs is stirred to be mixed in an aqueous solution of PAS derivative to prepare a slurry. By forming the slurry into a film, a PAS composition in which PEs is dispersed can be formed into a film. A known method can be used for the film formation method of the slurry, and casting is preferred because the slurry may be gel-like or have high viscosity. The film-shaped PAS composition can be dried by a known method.

The temperature during drying is preferably 10° C. or higher and 60° C. or lower, more preferably 20° C. or higher and 50° C. or lower, and further preferably 20° C. or higher and 45° C. or lower. When the temperature during drying is 10° C. or higher, loop stiffness can be lowered (the film can be made flexible). When the temperature during drying is 20° C. or higher and 50° C. or lower, loop stiffness can be further lowered. The humidity during drying (relative humidity RH) is 35% RH or higher and 95% RH or lower, preferably 45% RH or higher and 95% RH or lower, more preferably 55% RH or higher and 95% RH or lower, further preferably 60% RH or higher and 95% RH or lower, particularly preferably 70% RH or higher and 95% RH or lower, and most preferably 80% RH or higher and 95% RH or lower. As the humidity during drying increases, loop stiffness can be lowered. When the film is produced by freeze-drying, the retaining the planar shape tends to be less likely to manifest. In freeze-drying, the PAS structure is fixed in the sol state by freezing and then dried in the frozen state, resulting in a large number of voids within the film. When the film comes into contact with water, a large amount of water enters these voids, thereby increasing the contact between the water and the PAS. Accordingly, even if the solubility in water is reduced, the effect of retaining the planar shape is considered less likely to manifest. In addition, because the film produced by freeze-drying contains many voids as described above, the thickness of the film tends to increase, the loop stiffness value tends to be higher, and the film becomes more difficult to roll up.

The dried film-shaped PAS composition may be further subjected to heat press treatment. By the heat treatment, an adhesion barrier film having further reduced solubility in water can be obtained. Accordingly, a period of time in which the structure of the film is retained in a body can be made longer while flexibility of the film is maintained. From the perspective of external appearance and handleability, the heat treatment temperature is preferably from 110° C. to 150° C. The heat treatment time is preferably 1 minute or more and 400 minutes or less, more preferably 1 minute or more and 200 minutes or less, and further preferably 1 minute or more and 120 minutes or less. In addition, without performing the heat treatment, it is also possible to adjust solubility in water, for example, to increase solubility in water, by changing the content of PEs, the form such as thickness, and/or the added amount of the activator relative to PAS.

### EXAMPLES

Embodiments of the present invention will be described specifically below based on examples, but the present invention is not limited to these examples.

### 1. Quantification of Acid Generation Accompanying Hydrolysis of Biodegradable Polyester

### 1-1. Preparation of Biodegradable Polyester

### 1-1-1. Preparation of Particulate Polyglycolic Acid

Synthesis of polyglycolic acid was performed in accordance with the method described in Japanese Patent No. 5651026.

### (1) Preparation of Glycolide

A glycolic acid aqueous solution having a concentration of 70 mass % was charged into a reaction vessel, heated to 200° C., and subjected to a condensation reaction while water was distilled out of the system. Next, while the internal pressure of the vessel was stepwise reduced, low-boiling substances such as generated water and unreacted raw materials were distilled off to obtain a glycolic acid oligomer.

Diethylene glycol dibutyl ether was added to the reaction vessel containing the obtained glycolic acid oligomer, and octyl tetraethylene glycol was further added as a solubilizing agent, followed by depolymerization reaction under heating and reduced pressure to obtain glycolide. The obtained glycolide was purified using a column-type purification device. The purified glycolide had a purity of 99.99% or higher as measured by DSC.

### (2) Polymerization of Glycolide

The above purified glycolide, tin (II) chloride dihydrate, and water or dodecanol were added into a sealable container, the container was sealed, and heated to 100° C. while stirring the contents to melt the contents and form a homogeneous liquid. While maintaining the temperature of the contents at 100° C., the contents were transferred to a reactor and polymerized by holding at 170° C. for 7 hours to obtain polyglycolic acid (PGA).

The number average molecular weight Mn of PGA was adjusted by the moisture content in the polymerization system. The number average molecular weight Mn of PGA was determined by measurement in accordance with ISO 16014-1:2012. Specifically, gel permeation chromatography (GPC) (shodex GPC-104, available from Resonac Corporation, detector: RI, column: HFIP-606M×2) was used, a solution prepared by dissolving CF₃COONa in hexafluoroisopropanol (HFIP) to 5 mM was used as a solvent, and polymethyl methacrylate (PMMA) was used as a standard substance.

### (3) Pulverization of PGA

The obtained PGA flakes were pulverized 3 times using a turbo mill (Turbo Mill TT250 type, available from Freund-Turbo Corporation) at a feed rate of 10 kg/h, pulverization temperature of 20° C., and rotation speed of 5000 rpm, followed by 5 times pulverization using a jet mill (PJM-280SP, available from Nippon Pneumatic Mfg. Co., Ltd.) at a feed rate of 1 kg/h. Coarse powder was removed using an ultrasonic vibrating sieve with an aperture of 38 μm to obtain PGA, PLGA, and PLA particles with volume average particle sizes of 16.0-30.2 μm. Similarly, fine powder was removed using an ultrasonic vibrating sieve with an aperture of 75 μm to obtain PGA particles with a volume average particle size of 113.9 μm. The average particle size of PEs particles before dispersion was measured by the method described in Particle Size Analysis-Laser Diffraction/Scattering Method JIS Z 8825:2022 (ISO13320: 2020). Specifically, 20-30 mg of each type of PGA particle was added to 2 mL of ultrapure water to prepare a dispersion. The dispersion was added to the measurement cell in an amount of approximately 1-1.5 mL so that the sample concentration in the cell became approximately 0.1 wt %. After ultrasonic treatment, the average particle size was measured using a Microtrac (MT3300). The average particle size refers to the particle size at which the volume-based cumulative distribution reaches 50%.

### 1-1-2. Polyglycolic Acid Fibers, Polylactic Acid Powder, Copolymer Powder of Lactic Acid and Glycolic Acid

As the bioabsorbable polyester, polyglycolic acid (PGA) fibers, powder of a copolymer of DL-lactic acid and glycolic acid (PLGA), and powder of polylactic acid (PLA) listed below were used. For the raw materials of polyglycolic acid, polyglycolic acids having different molecular weights and a commercially available polyglycolic acid suture were used.

### 1-2. Hydrolysis of Biodegradable Polyester

The biodegradable polyester was dispersed in ultrapure water, and hydrolysis of the biodegradable polyester was performed. Table 1 shows the composition and properties of each biodegradable polyester used in the examples, and the masses of the biodegradable polyester and ultrapure water used for hydrolysis. The number average molecular weight Mn of PGA is the value measured above, and the number average molecular weights Mn of polyglycolic acid fibers, polylactic acid powder, and copolymer powder of lactic acid and glycolic acid are values published by the manufacturers.

TABLE 1

| | Biodegradable polyester (PEs) | | | | | | | | |
|---|---|---|---|---|---|---|---|---|---|
| | | | Number | Sieving | | Volume | | | |
| | | | average | conditions | | average | Added | Ultrapure | |
| Name | | | molecular | | Sieve | particle | amount | water | PEs |
| of PEs | | | weight | Aperture/ | retain/ | size/ | of Pes/ | amount/ | concentration/ |
| sample | Composition | Shape | Mn/Da | μm | pass | μm | mg | mL | mg/mL |
| PGA-P1 | PGA | POWDER | 11,000 | 38 | Pass | 16.0 | 13.0 | 12.4 | 1.05 |
| PGA-P1B | PGA | POWDER | 11,000 | 75 | ON | 104.5 | 13.0 | 12.4 | 1.05 |
| PGA-P1C | PGA | POWDER | 11,000 | 38 | Pass | 46.4 | — | — | — |
| | | | | 75 | ON | | | | |
| PGA-P2 | PGA | POWDER | 3,000 | 38 | Pass | 16.2 | 16.7 | 16.0 | 1.04 |
| PGA-P3 | PGA | POWDER | 31,000 | 38 | Pass | 24.6 | 16.7 | 16.0 | 1.04 |
| PGA-P4 | PGA | POWDER | 71,000 | 38 | Pass | 21.1 | 16.7 | 16.0 | 1.04 |
| PGA-P5 | PGA | POWDER | 200,000 | 38 | Pass | 28.9 | 16.7 | 16.0 | 1.04 |
| PGA-P6 | PGA | POWDER | 25,000 | 38 | Pass | 28.2 | 16.7 | 16.0 | 1.04 |
| PGA-P7 | PGA | POWDER | 35,000 | 38 | Pass | 23.5 | 16.7 | 16.0 | 1.04 |
| PGA-F1¹⁾ | PGA | Fibers | 100,000 | | Pass | Length | 16.7 | 16.0 | 1.04 |
| | | | | | | 2 mm | | | |
| PLGA-P1²⁾ | PLGA | POWDER | 4,000 to | — | Pass | 23.8 | 19.7 | 16.0 | 1.23 |
| | | | 15,000 | | | | | | |
| PLGA-P2³⁾ | PLGA | POWDER | 7,000 to | — | Pass | 24.1 | 18.7 | 16.0 | 1.17 |
| | | | 17,000 | | | | | | |
| PLA-P1⁴⁾ | PLA | POWDER | 10,000 to | — | Pass | 30.1 | 20.7 | 16.0 | 1.29 |
| | | | 18,000 | | | | | | |

¹⁾PGA-F1: Suture (“SURGISORB” 3-0 available from BEAR Medic Corporation)
²⁾PLGA-P1: Purchased from SIGMA (“RESOMER RG 752H” available from Evonik, Lactide: Glycolide = 75:25 (w/w))
³⁾PLGA-P2: Purchased from SIGMA (“RESOMER RG 502H” available from Evonik, Lactide: Glycolide = 50:50 (w/w))
⁴⁾PLA-P1: Purchased from SIGMA (“RESOMER R 202H” available from Evonik)

### 1-3. Quantification of Amount of Acid Generated by Hydrolysis of Biodegradable Polyester

The amount of acid generated by hydrolysis of a biodegradable polyester was measured by neutralization titration using 1,8-diazabicyclo[5.4.0]-7-undecene (hereinafter, may be referred to as “DBU”). The DBU solution was titrated in advance using a 0.01 N hydrochloric acid standard solution, and its concentration was standardized. After the dispersion solutions in which the PEs listed in Table 1 were dispersed were kept in water at 37° C. for a predetermined time, the acid concentration in each solution was titrated with the DBU solution, and the neutralization point was confirmed using a 0.04 mass % aqueous solution of bromothymol blue as an indicator. Table 2 shows the changes over time in each acid concentration Ca (mmol/L) in the dispersion solution. The acid releasing ability Ar (mol %/day) was defined as a value obtained by calculating the percentage of the amount of substance of acid generated in water at 37° C. with respect to an ideal amount of substance of an acid generated when all the biodegradable polyester is hydrolyzed, and dividing the percentage by the number of days elapsed. In Table 1 and Table 2, “-” indicates “not performed”.

TABLE 2
Acid Concentration and Acid Releasing Ability of Biodegradable Polyester (PEs) Dispersion Solution

| | Number | | | | | | | | |
|---|---|---|---|---|---|---|---|---|---|
| | average | | | | | | | | |
| | molecular | Elapsed time (h) | | | | | | | |
| PEs | weight | 24 | | 72 | | 120 | | 168 | |
| material | Mn/Da | Ca | Ar | Ca | Ar | Ca | Ar | Ca | Ar |
| PGA-P1 | 11,000 | 0.759 | 4.21 | 1.730 | 3.20 | 2.298 | 2.55 | 2.709 | 2.15 |
| PGA-P1B | 11,000 | 0.043 | — | 0.099 | — | 0.131 | — | 0.155 | — |
| PGA-P1C | 11,000 | — | — | — | — | — | — | — | — |
| PGA-P2 | 3,000 | 2.964 | 16.56 | 3.497 | 6.52 | 3.954 | 4.42 | 4.713 | 3.77 |
| PGA-P3 | 31,000 | 0.128 | 0.71 | 0.238 | 0.44 | 0.420 | 0.47 | 0.812 | 0.65 |
| PGA-P4 | 71,000 | 0.037 | 0.20 | 0.077 | 0.14 | 0.108 | 0.12 | 0.133 | 0.11 |
| PGA-P5 | 200,000 | 0.011 | 0.06 | 0.020 | 0.04 | 0.021 | 0.02 | 0.098 | 0.08 |
| PGA-P6 | 25,000 | 0.045 | — | 0.255 | — | 0.828 | — | 1.297 | — |
| PGA-P7 | 35,000 | 0.031 | — | 0.095 | — | 0.371 | — | 0.688 | — |
| PGA-F1 | — | — | — | — | — | — | — | 0.007 | — |
| PLGA-P1 | 4,000 to | 0.020 | 0.11 | 0.040 | 0.07 | 0.115 | 0.13 | 0.495 | 0.39 |
| | 15,000 | | | | | | | | |
| PLGA-P2 | 7,000 to | 0.006 | 0.03 | 0.075 | 0.14 | 0.148 | 0.17 | 0.911 | 0.73 |
| | 17,000 | | | | | | | | |
| PLA-P1 | 10,000 to | 0.017 | 0.09 | 0.028 | 0.05 | 0.025 | 0.03 | 0.086 | 0.07 |
| | 18,000 | | | | | | | | |

According to Table 2, in the aqueous solution in which PEs is dispersed, acid is generated by hydrolysis, and the acid concentration in the aqueous solution tends to increase over time. In the solution in which PGA powder is dispersed, it can be seen that the smaller the number average molecular weight Mn of PGA, the greater the amount of acid generated by hydrolysis. In the sample in which a PGA suture was cut short, acid generation was scarcely detected. Acid generation was also measured for PLA, but the amount of generated acid is smaller than that of PGA.

### 2. Preparation of Adhesion Barrier Film

### 2-1. Preparation of Adhesion Barrier Film

### 2-1-1. Adhesion Barrier Film 1-1

In 800 mL of ultrapure water, 4.4 g of sodium hyaluronate (molecular weight: 2,200,000 Da) was dissolved, then 2.0 g of sodium carboxymethylcellulose (molecular weight: 150,000 Da) was added to prepare a mixed solution. While 0.1 mol/L hydrochloric acid was added to the mixed solution to maintain the pH at 4.5 to 5.2, an aqueous EDC solution prepared by dissolving 8.5 g of 1-ethyl-3-(3-dimethylaminopropyl) carbodiimide (EDC) in 20 ml of ultrapure water was added dropwise in its entirety to the mixed solution to obtain a reaction solution. The pH was adjusted with 0.1 mol/L hydrochloric acid while stirring the reaction solution for 1.5 to 2.0 hours until the change in the pH of the reaction solution became small. The obtained reaction solution was subjected to dialysis using a regenerated cellulose dialysis tube with a molecular weight cut-off of 12,000 to 14,000, and low molecular weight components such as unreacted materials and byproducts were removed while exchanging the dialysate. The dialysate was exchanged 3 times during 36 hours from the start of the dialysis. In this manner, an HA/CMC solution in which carboxyl groups were activated using EDC and ester bonds were formed between molecules was obtained.

To 90 g of the obtained HA/CMC solution, 31.5 mg of PGA-P1 was added and uniformly dispersed. Here, when the number of structural units of HA in the HA/CMC solution is N_{HA} and the number of structural units of added PGA is N_{PGA}, N_{PGA}/N_{HA} (the ratio of N_{PGA} to N_{HA}) corresponds to 0.5. The HA/CMC solution to which PGA-P1 was added was poured into a mold of 110 mm length×110 mm width made of glass plate and silicone rubber, and air-dried at room temperature (25° C.) in an environment of approximately 40% relative humidity. The film obtained by air-drying was heat-treated at 90° C. for 15 minutes at a gauge pressure of 4.0 MPaG, followed by 120° C. for 10 minutes at a gauge pressure of 4.0 MPaG using a heat press device, thereby preparing an adhesion barrier film 1-1.

### 2-1-2. Adhesion Barrier Film 1-2

An adhesion barrier film 1-2 was prepared in the same manner as the adhesion barrier film 1-1 except that the added amount of PGA-P1 to 90 g of the HA/CMC solution was changed to 63 mg (N_{PGA}/N_{HA} equivalent to 1.0).

### 2-1-3. Adhesion Barrier Film 1-3

An adhesion barrier film 1-3 was prepared in the same manner as the adhesion barrier film 1-1 except that the added amount of PGA-P1 to 90 g of the HA/CMC solution was changed to 126 mg (N_{PGA}/N_{HA} equivalent to 2.0).

### 2-1-4. Adhesion Barrier Film 1

An adhesion barrier film 1 was prepared in the same manner as the adhesion barrier film 1-1 except that the added amount of PGA-P1 to 90 g of the HA/CMC solution was changed to 252 mg (N_{PGA}/N_{HA} equivalent to 4.0).

### 2-1-5. Adhesion Barrier Film 1B-1

An adhesion barrier film 1B-1 was prepared in the same manner as the adhesion barrier film 1 except that the biodegradable polyester PGA-P1 was changed to PGA-P1B and the added amount of PGA-P1B was set to 252 mg (N_{PGA}/N_{HA} equivalent to 4.0).

### 2-1-6. Adhesion Barrier Film 1B-2

An adhesion barrier film 1B-2 was prepared in the same manner as the adhesion barrier film 1 except that the biodegradable polyester PGA-P1 was changed to PGA-P1B and the added amount of PGA-P1B was set to 63 mg (N_{PGA}/N_{HA} equivalent to 1.0).

### 2-1-7. Adhesion Barrier Film 1C

An adhesion barrier film 1C was prepared in the same manner as the adhesion barrier film 1 except that the biodegradable polyester PGA-P1 was changed to PGA-P1C and the added amount of PGA-P1C was set to 63 mg (N_{PGA}/N_{HA} equivalent to 1.0).

### 2-1-8. Adhesion Barrier Film 2

An adhesion barrier film 2 was prepared in the same manner as the adhesion barrier film 1-1 except that PGA-P1 was not added to 90 g of the HA/CMC solution. The mass of the adhesion barrier film prepared from 90 g of HA/CMC solution was 710 mg.

### 2-1-9. Adhesion Barrier Film 3

A commercially available adhesion barrier material (“Seprafilm” available from Sanofi; “Seprafilm” is a registered trademark of Baxter) was used as adhesion barrier film 3.

### 2-1-10. Adhesion Barrier Film 4

An adhesion barrier film 4 was prepared in the same manner as the adhesion barrier film 1 except that the biodegradable polyester PGA-P1 was changed to PGA-P2 and the added amount of PGA-P2 was set to 252 mg (N_{PGA}/N_{HA} equivalent to 4.0).

### 2-1-11. Adhesion Barrier Film 4-1

An adhesion barrier film 4-1 was prepared in the same manner as the adhesion barrier film 4 except that the added amount of PGA-P2 to 90 g of the HA/CMC solution was changed to 31.5 mg (N_{PGA}/N_{HA} equivalent to 0.5).

### 2-1-12. Adhesion Barrier Film 4-2

An adhesion barrier film 4-2 was prepared in the same manner as the adhesion barrier film 4 except that the added amount of PGA-P2 to 90 g of the HA/CMC solution was changed to 18.9 mg (N_{PGA}/N_{HA} equivalent to 0.3).

### 2-1-13. Adhesion Barrier Film 5

An adhesion barrier film 5 was prepared in the same manner as the adhesion barrier film 1 except that the biodegradable polyester PGA-P1 was changed to PGA-P6 and the added amount of PGA-P6 to 90 g of the HA/CMC solution was set to 252 mg (N_{PGA}/N_{HA} equivalent to 4.0).

### 2-1-14. Adhesion Barrier Film 5-1

An adhesion barrier film 5-1 was prepared in the same manner as the adhesion barrier film 1 except that the biodegradable polyester PGA-P1 was changed to PGA-P6 and the added amount of PGA-P6 to 90 g of the HA/CMC solution was set to 126 mg (N_{PGA}/N_{HA} equivalent to 2.0).

### 2-1-15. Adhesion Barrier Film 5-2

An adhesion barrier film 5-2 was prepared in the same manner as the adhesion barrier film 1 except that the biodegradable polyester PGA-P1 was changed to PGA-P6 and the added amount of PGA-P6 to 90 g of the HA/CMC solution was set to 63 mg (N_{PGA}/N_{HA} equivalent to 1.0).

### 2-1-16. Adhesion Barrier Film 6

An adhesion barrier film 6 was prepared in the same manner as the adhesion barrier film 1 except that the biodegradable polyester PGA-P1 was changed to PGA-P7 and the added amount of PGA-P7 to 90 g of the HA/CMC solution was set to 252 mg (N_{PGA}/N_{HA} equivalent to 4.0).

### 2-1-17. Adhesion Barrier Film 7

An adhesion barrier film 7 was prepared in the same manner as the adhesion barrier film 1 except that the drying conditions for the film were changed from air-drying to 70° C. and 80% RH relative humidity.

### 2-1-18. Adhesion Barrier Film 8

An adhesion barrier film 8 was prepared in the same manner as the adhesion barrier film 1 except that the drying conditions for the film were changed from air-drying to 30° C. and 80% RH relative humidity.

No change was observed in the average particle size of PEs particles before and after heat pressing.

Table 3 shows the type of PEs, drying condition, and heat press condition used in the production of each adhesion barrier film. In Table 3, “-” indicates “not performed”.

TABLE 3

| No. of | Biodegradable polyester | | | | | | | | | | |
|---|---|---|---|---|---|---|---|---|---|---|---|
| material | | | Added | | | Heat press condition | | | | | |
| of | | Number | Amount to | | | First stage | | | Second stage | | |
| adhesion | | average | 90 g of HA/CMC | | | | Gauge | | | Gauge | |
| barrier | Material | molecular | Solution | | Drying | Temp/ | pressure/ | Time/ | Temp./ | pressure/ | Time/ |
| film | of PEs | weight/Da | Mg | N_{PGA}/N_{HA} | condition | ° C. | MPaG | min | ° C. | MPaG | min |
| 1-1 | PGA-P1 | 11,000 | 31.5 | 0.5 | Room | 90 | 4 | 15 | 120 | 4 | 10 |
| | | | | | temperature/ | | | | | | |
| | | | | | Air-drying | | | | | | |
| 1-2 | PGA-P1 | 11,000 | 63.0 | 1.0 | Room | 90 | 4 | 15 | 120 | 4 | 10 |
| | | | | | temperature/ | | | | | | |
| | | | | | Air-drying | | | | | | |
| 1-3 | PGA-P1 | 11,000 | 126.0 | 2.0 | Room | 90 | 4 | 15 | 120 | 4 | 10 |
| | | | | | temperature/ | | | | | | |
| | | | | | Air-drying | | | | | | |
| 1 | PGA-P1 | 11,000 | 252.0 | 4.0 | Room | 90 | 4 | 15 | 120 | 4 | 10 |
| | | | | | temperature/ | | | | | | |
| | | | | | Air-drying | | | | | | |
| 1B-1 | PGA-P1B | 11,000 | 252.0 | 4.0 | Room | 90 | 4 | 15 | 120 | 4 | 10 |
| | | | | | temperature/ | | | | | | |
| | | | | | Air-drying | | | | | | |
| 1B-2 | PGA-P1B | 11,000 | 63.0 | 1.0 | Room | 90 | 4 | 15 | 120 | 4 | 10 |
| | | | | | temperature/ | | | | | | |
| | | | | | Air-drying | | | | | | |
| 1C | PGA-P1C | 11,000 | 63.0 | 1.0 | Room | 90 | 4 | 15 | 120 | 4 | 10 |
| | | | | | temperature/ | | | | | | |
| | | | | | Air-drying | | | | | | |
| 2 | — | — | 0.0 | 0.0 | Room | 90 | 4 | 15 | 120 | 4 | 10 |
| | | | | | temperature/ | | | | | | |
| | | | | | Air-drying | | | | | | |
| 3 | — | — | — | | — | — | — | — | — | — | — |
| 4 | PGA-P2 | 3,000 | 252.0 | 4.0 | Room | 90 | 4 | 15 | 120 | 4 | 10 |
| | | | | | temperature/ | | | | | | |
| | | | | | Air-drying | | | | | | |
| 4-1 | PGA-P2 | 3,000 | 31.5 | 0.5 | Room | 90 | 4 | 15 | 120 | 4 | 10 |
| | | | | | temperature/ | | | | | | |
| | | | | | Air-drying | | | | | | |
| 4-2 | PGA-P2 | 3,000 | 18.9 | 0.3 | Room | 90 | 4 | 15 | 120 | 4 | 10 |
| | | | | | temperature/ | | | | | | |
| | | | | | Air-drying | | | | | | |
| 5 | PGA-P6 | 25,000 | 252.0 | 4.0 | Room | 90 | 4 | 15 | 120 | 4 | 10 |
| | | | | | temperature/ | | | | | | |
| | | | | | Air-drying | | | | | | |
| 5-1 | PGA-P6 | 25,000 | 126.0 | 2.0 | Room | 90 | 4 | 15 | 120 | 4 | 10 |
| | | | | | temperature/ | | | | | | |
| | | | | | Air-drying | | | | | | |
| 5-2 | PGA-P6 | 25,000 | 63.0 | 1.0 | Room | 90 | 4 | 15 | 120 | 4 | 10 |
| | | | | | temperature/ | | | | | | |
| | | | | | Air-drying | | | | | | |
| 6 | PGA-P7 | 35,000 | 252.0 | 4.0 | Room | 90 | 4 | 15 | 120 | 4 | 10 |
| | | | | | temperature/ | | | | | | |
| | | | | | Air-drying | | | | | | |
| 7 | PGA-P1 | 11,000 | 252.0 | 4.0 | 70° C., 80% | 90 | 4 | 15 | 120 | 4 | 10 |
| 8 | PGA-P1 | 11,000 | 252.0 | 4.0 | 30° C., 80% | 90 | 4 | 15 | 120 | 4 | 10 |

### 3. Evaluation

### 3-1. Evaluation of Shape Change of Adhesion Barrier Film

A sample (dimensions: 10 mm×10 mm, area 100 mm²) of each of the prototype adhesion barrier films 1-1 to 1-3, 1, 1B-1, 1B-2, 1C, 2 to 4, 4-1, 4-2, 5, 5-1, 5-2 and 6 to 8 was immersed in 8 mL of a phosphate buffer at 37° C. with a salt concentration of 0.2 mol/L and pH of 7.3, and the shape change was evaluated. At the elapsed times of 72 hours, 120 hours, and 168 hours from the start of immersion, the external appearance of each sample was observed and the shape was evaluated. It was determined that the shape of the film was maintained when the score described below was 2 or greater.

For the result of the external appearance observation, one of the following scores was assigned for each of external appearance images of the adhesion barrier films, and the result was expressed by an average value of the scores judged by a plurality of (five) experienced and skilled technicians while the image was referred.
4 Points: The external appearance was substantially the same as the planar shape of the sample before the immersion.
3 Points: Although the external appearance was overall expanded from the planar shape of the sample before the immersion, presence of the sample was able to be visually confirmed.
2 Points: Although the external appearance was overall expanded from the planar shape of the sample and included somewhat disintegrated part, presence of the sample was able to be visually confirmed.
1 Point: It was confirmed that the external appearance was in an indeterminate form by liquid drop.
0 Points: The external appearance was not confirmed due to dissolution.

### 3-2. Thickness

The thickness of an adhesion barrier film was measured by the following method. For a square-shaped adhesion barrier film, the film was divided into 16 divided areas by drawing perpendicular lines from points that divide each side into four equal segments toward an opposing side. The central portion of each divided area was measured with a micrometer (PMU150-25MX available from Mitutoyo Corporation), and the average value was defined as the film thickness. Here, the central portion of each divided area refers to the region including the intersection of the diagonals of a rectangle defining the divided area.

### 3-3. Loop Stiffness

Loop stiffness was measured by the following method. For a rectangular adhesion barrier film, the film was divided into four divided areas by drawing a perpendicular line from the center of each side toward the opposing side. A sample piece was prepared by cutting the film into a 10 mm×40 mm rectangle so as to include the central portion of each divided area. Both ends of the rectangular film (sample piece) in the longitudinal direction were aligned and adhered to each other with double-sided tape at a width of 5 mm from each end to prepare a measurement sample in a loop shape (teardrop shape) with a loop length of 30 mm. Measurement was performed at a temperature of 25° C. and a relative humidity of approximately 60% RH, and the portion adhered to each other with double-sided tape (5 mm) was clamped and fixed in a chuck of a creep meter (RHEONER II RE2-33005B, available from Yamaden Co., Ltd.). To compress the loop of the measurement sample, the upper indenter (φ30 mm) attached to the creep meter was moved in the loop direction at a speed of 0.5 mm/sec. A load (N) at the time of compression by 5 mm from a contact point was recorded and defined as a loop stiffness value (N/10 mm). Measurement was performed four times (n=4), and the average of the measured values obtained was defined as the loop stiffness value.

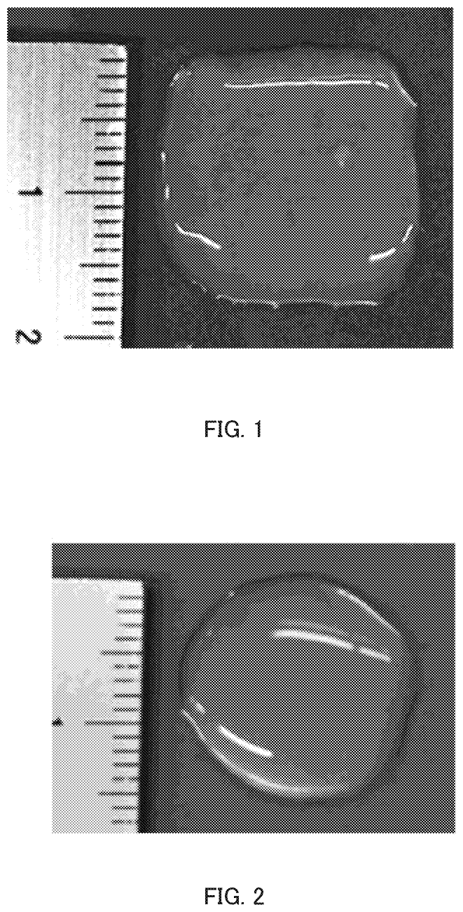

Table 4 shows the PGA content in the dried adhesion barrier film calculated from the added amount of PGA to 90 g of the HA/CMC solution, the evaluation results of external appearance, and the measurement results of thickness and loop stiffness. Furthermore, FIG. 1 is a photograph showing a typical external appearance with the score of 2 described above. FIG. 2 is a photograph showing a typical external appearance with the score of 1 described above. In Table 4, “-” indicates “not performed”.

TABLE 4

| | No. of | | | | | | Thickness | |
|---|---|---|---|---|---|---|---|---|
| | material | PEs content in | | Observation of external | | | of | Loop |
| | of | adhesion barrier | | appearance of film | | | adhesion | Stiffness |
| | adhesion | film | | Elapsed time | | | barrier | Before |
| | barrier | PEs | Content/ | (h) | | | film/ | correction |
| | film | Material | mass % | 72 | 120 | 168 | μm | N/10 mm |
| Comparative | 1-1 | PGA-P1 | 4.25 | 3.2 | 1.0 | 1.0 | 50 | 0.15 |
| Example | | | | | | | | |
| Example | 1-2 | PGA-P1 | 8.15 | 3.4 | 2.0 | 1.0 | 54 | 0.15 |
| Example | 1-3 | PGA-P1 | 15.07 | 3.0 | 2.0 | 1.0 | 65 | 0.17 |
| Example | 1 | PGA-P1 | 26.20 | 3.0 | 2.0 | 1.0 | 72 | 0.20 |
| Comparative | 1B-1 | PGA-P1B | 26.20 | 3.0 | 1.0 | 1.0 | 211 | 0.27 |
| Example | | | | | | | | |
| Comparative | 1B-2 | PGA-P1B | 8.15 | 3.2 | 1.0 | — | — | — |
| Example | | | | | | | | |
| Example | 10 | PGA-1C | 8.15 | 3.2 | 2.0 | — | — | — |
| Comparative | 2 | — | 0.00 | 3.0 | 1.0 | 1.0 | 53 | 0.17 |
| Example | | | | | | | | |
| Comparative | 3 | — | — | 2.6 | 0.0 | 0.0 | 46 | 0.09 |
| Example | | | | | | | | |
| Example | 4 | PGA-P2 | 26.20 | 3.5 | 2.4 | 1.0 | 55 | 0.11 |
| Example | 4-1 | PGA-P2 | 4.25 | 3.0 | 2.0 | 1.0 | 62 | 0.20 |
| Comparative | 4-2 | PGA-P2 | 1.39 | 3.0 | 1.0 | 1.0 | 50 | 0.15 |
| Example | | | | | | | | |
| Example | 5 | PGA-P6 | 26.20 | 3.0 | 2.4 | 1.0 | 78 | 0.28 |
| Example | 5-1 | PGA-P6 | 15.07 | 3.0 | 2.4 | 1.0 | — | — |
| Comparative | 5-2 | PGA-P6 | 8.15 | 3.0 | 1.0 | 1.0 | — | — |
| Example | | | | | | | | |
| Comparative | 6 | PGA-P7 | 8.09 | 3.0 | 0 | 0 | 65 | 0.25 |
| Example | | | | | | | | |
| Example | 7 | PGA-P1 | 26.20 | 3.0 | 2.0 | 1.0 | 73 | 0.15 |
| Example | 8 | PGA-P1 | 26.20 | 3.0 | 2.0 | 1.0 | 68 | 0.25 |

From the results of Table 4, the adhesion barrier films (1-1, 1-2, 1, 1C, 4, 4-1, 5, 5-1, 7 and 8) containing 3 mass % or greater of biodegradable polyester particles, wherein the particles have the number average molecular weight (Mn) of 1,000 Da or greater and less than 30,000 Da and an average particle size of 1 μm or greater and 60 μm or less, retained their planar shape even after 120 hours elapsed from immersion. On the other hand, adhesion barrier films 2 and 3 containing no PGA, adhesion barrier films 1-1 and 4-2 with a small added amount of PGA, film 1B-1 and 1B-2 containing PGA-P1B (having an average particle size of 104.5 μm), and film 6 containing PGA-P7 (having a number average molecular weight Mn of 35,000) showed significant shape changes or their shapes could not be confirmed at the time when 120 hours elapsed from immersion.

As shown in Table 4, as the added amount of PEs contained in an adhesion barrier film increased, the period of time in which the film shape was retained became longer. In addition, as the number average molecular weight of PGA decreases, the period during which the film shape is retained increases.

### 4. Relationship Between Number Average Molecular Weight of Biodegradable Polyester and Content of Biodegradable Polyester for Retaining Shape of Adhesion Barrier Film

PGA tends to be more readily hydrolyzed as its number average molecular weight decreases, and the acid concentration and the acid releasing ability after an elapsed time tend to become higher. The released acid has the effect of suppressing the disintegration of the adhesion barrier film and retaining the planar shape. The amount of generated acid is determined by the molecular weight of the PGA added and the ratio of PGA added to the adhesion barrier film.

The mass of adhesion barrier film 2, which was prepared without adding bioabsorbable polyester to 90 g of the HA/CMC solution, is 710 mg (see 2-1-5.), so when W_{PGA-P2} mg of PGA-P2 is added to the HA/CMC, since the content of PGA-P2 in the adhesion barrier film is 3 mass %, the following relationship is given:

$$\frac{{W}_{PGA - P 2}}{710 + {W}_{PGA - P 2}} \times 100 = 3$$

Accordingly, W_{PGA-P2} is calculated to be 22.0 mg.

From Table 2, it can be seen that there is a tendency for the acid concentration to decrease as the number average molecular weight of PGA increases. Table 5 shows respective masses of PGA-P1 and PGA-P6 required to achieve the same acid concentration as that obtained after 120 hours when 22.0 mg of PGA-P2 is added, and contents of PEs in the dried adhesion barrier films.

TABLE 5

| | Number | | | PGA content in |
|---|---|---|---|---|
| | average | Acid | | dried adhesion |
| | molecular | concentration | Added PGA/ | barrier |
| PEs | weight/ | after 120 h/ | amount of | film/ |
| Material | Da | mmol/L | mg | mass % |
| PGA-P2 | 3000 | 3.954 | 22.0 | 5.1 |
| PGA-P1 | 11000 | 2.298 | 37.8 | 3.0 |
| PGA-P6 | 25000 | 0.828 | 104.9 | 12.9 |

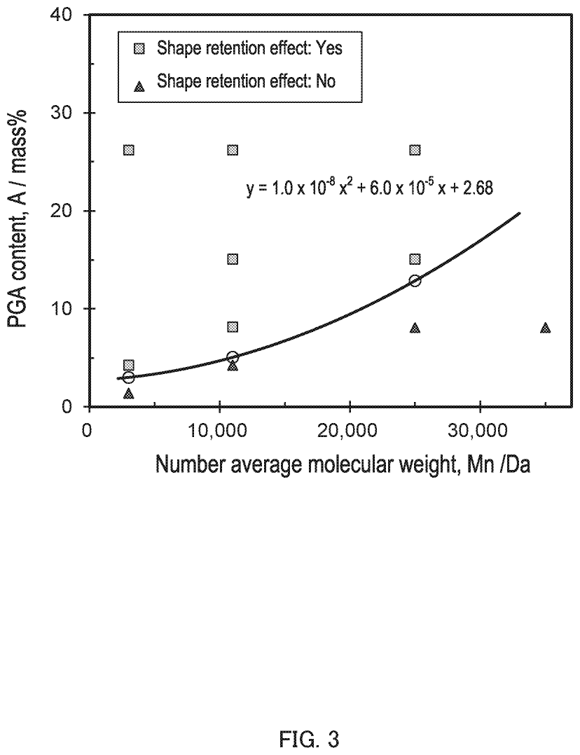

FIG. 3 shows, regarding a relationship between an average molecular weight of PGA and a PGA content in an adhesion barrier film required for retaining a planar shape even after immersion in water for 120 h, the values in Table 5 (circles), other experimental results (squares), and adhesion barrier films for which an effect was not observed (triangles). From these results, an approximate curve obtained by approximating the relationship with a quadratic function by the least squares method is expressed by the following Expression, where the number average molecular weight of PGA is defined as Mn and the PGA content is defined as A.

$$A = 1.0 \times 1 {0}^{- 8} {Mn}^{2} + 6.0 \times 1 {0}^{- 5} Mn + 2.68 \qquad Expression 1$$

From FIG. 3, the content A (mass %) of PGA contained in the adhesion barrier film having a high planar-shape retention effect satisfies the following Expression:

$$A ≧ 1.0 \times 1 {0}^{- 8} {Mn}^{2} + 6.0 \times 1 {0}^{- 5} Mn + 2.68 .$$

In addition, since the above formula is also satisfied in the adhesion barrier film 1C, it can be seen that the content A (mass %) of PGA contained in the adhesion barrier film, which has a high planar shape retention effect at least when the average particle diameter is 60 μm or less, satisfies the formula in the previous section.

### 3. Verification of Adhesion Prevention Effect

To confirm the adhesion prevention effect of the adhesion barrier film of the present invention after surgery, evaluation was performed using a rat liver segmentectomy model.

### 3-1. Preparation of Adhesion Barrier Film

An adhesion barrier film 1-4 was prepared in the same manner as the adhesion barrier film 1 except that the amount of HA/CMC solution was changed to 100 g and the added amount of PGA-P1 was changed to 214.2 mg. In addition, an adhesion barrier film 2-1 was prepared in the same manner as the adhesion barrier film 2 except that the amount of the HA/CMC solution was changed to 100 g.

Using seven rats as one group, a part of the left lateral lobe of the liver of each rat was excised, and the excised surface was covered by closely adhering the adhesion barrier film 2-1 or the adhesion barrier film 1-4 thereto. On the seventh day after the surgical operation, dissection was performed, and adhesion between the liver excised surface and another tissue was scored as a degree of severity of adhesion (score criteria: 0=no adhesion, 1=adhesion that can be separated by own weight, 2=adhesion that can be separated by blunt dissection, 3=adhesion that requires sharp dissection). The results are shown in Table 4. In Table 4, for “degree of severity of adhesion,” the numeric value in “score” for the adhesion barrier film 2-1 or the adhesion barrier film 1-4 represents the number of rats that came under the score. The numeric value in “average” is a value calculated by dividing the sum total of products of scores for the adhesion barrier film 2-1 or the adhesion barrier film 1-4 and the number of rats by the number of rats.

TABLE 6

| | Degree of severity of adhesion | | | | |
|---|---|---|---|---|---|
| | Score | | | | |
| Material No. | 3 | 2 | 1 | 0 | Average |
| 1-4 | 1 | 1 | 0 | 5 | 0.7 |
| 2-1 | 3 | 4 | 0 | 0 | 2.4 |

As a result, as shown in Table 4, it was confirmed that the adhesion barrier film 1-4 containing the PGA-P1 had a high adhesion prevention effect.

### INDUSTRIAL APPLICABILITY

When the adhesion barrier film of the present invention is applied to a wound site of a body, the adhesion barrier film adheres closely to the surface of the wound site where adhesion prevention is desired and exhibits an effect of wound healing or adhesion prevention. Furthermore, the adhesion barrier film has flexibility that enables easy insertion of the film into the wound site.

1. An adhesion barrier film, comprising:
a derivative of a polyanionic polysaccharide, wherein
the adhesion barrier film contains 3 mass % or greater of biodegradable polyester particles having an average particle size of 1 μm or greater and 60 μm or less,
a number average molecular weight Mn of the biodegradable polyester particles is 1,000 Da or greater and less than 30,000 Da, and
a content A mass % of the biodegradable polyester with respect to the number average molecular weight Mn of the biodegradable polyester satisfies an expression below:
$$A ≧ 1.0 \times 1 {0}^{- 8} {Mn}^{2} + 6.0 \times 1 {0}^{- 5} Mn + 2.68 .$$

2. The adhesion barrier film according to claim 1, wherein
loop stiffness of the adhesion barrier film is 0.05 N/10 mm or greater and 0.30 N/10 mm or less.

3. The adhesion barrier film according to claim 1, wherein
the average particle size of the biodegradable polyester particles is 10 μm or greater and 30 μm or less.

4. The adhesion barrier film according to claim 1, wherein the derivative of the polyanionic polysaccharide contains at least hyaluronic acid or a derivative thereof and carboxymethyl cellulose or a derivative thereof as structural units.

5. The adhesion barrier film according to claim 1, wherein the biodegradable polyester particles are particles of a homopolymer of glycolic acid or lactic acid, or particles of a copolymer of glycolic acid and lactic acid.

6. A method for producing the adhesion barrier film according to claim 1, the method comprising:
preparing an aqueous solution containing a derivative of a polyanionic polysaccharide;
preparing biodegradable polyester particles having an average particle size of 1 μm or greater and 60 μm or less;
mixing and dispersing the biodegradable polyester particles in the aqueous solution to prepare a slurry; and
casting the slurry to obtain a film.
